(19) United States
(12) Patent Application Publication
(10) Pub. No.: US 2021/0294149 A1
(43) Pub. Date: Sep. 23, 2021

(54) COLOR FILTER SUBSTRATE, DISPLAY PANEL AND DISPLAY DEVICE

(71) Applicants: Beijing BOE Display Technology Co., Ltd., Beijing (CN); BOE Technology Group Co., Ltd., Beijing (CN)

(72) Inventors: Xibin SHAO, Beijing (CN); Xiaona LIU, Beijing (CN); Rui ZHANG, Beijing (CN)

(21) Appl. No.: 17/186,955

(22) Filed: Feb. 26, 2021

(30) Foreign Application Priority Data
Mar. 18, 2020 (CN) 202010193371.1

(51) Int. Cl. G02F 1/1335; G02F 1/1339

(52) U.S. Cl. CPC G02F 1/133514; G02F 1/1339; G02F 1/133512

(57) ABSTRACT

A color filter substrate, comprising a display area and a frame area surrounding the display area, wherein the color filter substrate further comprises: a substrate; and a color filter layer disposed on the substrate and in the display area, wherein the color filter layer has a non-right-angled shape at a corner region of the display area.

### CROSS-REFERENCE TO RELATED APPLICATIONS

The present application claims priority to a Chinese patent application under CN 202010193371.1, entitled “Color filter substrate, display panel and display device” and filed with China National Intellectual Property Administration (CNIPA) on Mar. 18, 2020, the content of which is incorporated herein by reference in its entirety for all purposes.

### TECHNICAL FIELD

Embodiments of the present disclosure relate to a color filter substrate, a display panel and a display device.

### BACKGROUND

Liquid Crystal Displays (LCDs) usually includes an array substrate and a color filter substrate, and the array substrate and the color filter substrate are bonded by a sealant layer. Due to limitations in processing, a corner region of the sealant layer has a shape of arc.

Pixels of a conventional color filter substrate are usually designed to be rectangular and arranged in array to form a rectangular display area. This leads to a very high risk that a color filter layer of the color filter substrate overlaps the sealant layer at a corner region of the display area. And in a non-corner region, the color filter layer does not overlap the sealant layer. This will easily cause a thickness of film layers between the array substrate and the color filter substrate at the corner region to be greater than a thickness of film layers at the non-corner region, resulting in uniform supporting at peripheral regions between the array substrate and the color filter substrate, causing yellowing at the corner region of the display panel.

### SUMMARY

At least some embodiments of the present disclosure provide a color filter substrate, including a display area and a frame area surrounding the display area, wherein the color filter substrate including:

a substrate; and

a color filter layer disposed on the substrate and in the display area, wherein the color filter layer has a non-right-angled shape at a corner region of the display area.

In some embodiments of the present disclosure, the color filter substrate comprises a plurality of pixels arranged in array, and each of the plurality of pixels comprise a plurality of sub-pixels; the color filter layer comprises a plurality of filter units of different colors corresponding to each of the plurality of sub-pixels; and at least one filter unit corresponding to one of the plurality of pixels at the corner region of the display area has a non-right-angled shape.

In some embodiments of the present disclosure, the color filter layer has a rounded shape at the corner region of the display area.

In some embodiments of the present disclosure, a rounding radius of the color filter layer at the corner region of the display area ranges from 0.5 mm to 5 mm.

In some embodiments of the present disclosure, the color filter layer has a chamfer at the corner region of the display area.

In some embodiments of the present disclosure, a chamfered angle of the chamfer is 45° and a length of the chamfer ranges from 0.5 mm to 8 mm.

In some embodiments of the present disclosure, the color filter substrate further comprises a black matrix disposed on a same side of the substrate as the color filter layer, wherein the black matrix comprises a first black matrix structure disposed in the display area and a second black matrix structure disposed in the frame area, and the color filter layer overlaps the second black matrix structure at least partially.

In some embodiments of the present disclosure, the color filter substrate further comprises a sealant layer disposed in the frame area and having a shape of arc in the corner region, a distance between a part of the color filter layer with the non-right angled structure and the sealant layer is greater than or equal to a distance between other part of the color filter layer rather than the part of the color filter layer with the non-right angled structure and the sealant layer.

In some embodiments of the present disclosure, the color filter substrate comprises a plurality of pixels arranged in array, and each of the plurality of pixels comprise a plurality of sub-pixels; the color filter layer comprises filter units of different colors corresponding to each of the sub-pixels; wherein at least one filter unit corresponding to one pixel at the corner region of the display area has a non-right-angled shape, and a distance between the at least one filter unit and the sealant layer is greater than or equal to a distance between filter units rather than the at least one filter unit and the sealant layer.

In some embodiments of the present disclosure, the at least one filter unit has an arc shape at the corner region of the display area.

In some embodiments of the present disclosure, an arc radius of the at least one filter unit at the corner region of the display area ranges from 0.5 mm to 5 mm.

In some embodiments of the present disclosure, the at least one filter unit has a chamfer at the corner region of the display area.

In some embodiments of the present disclosure, a chamfered angle of the chamfer is 45°, and a length of the chamfer ranges from 0.5 mm to 8 mm.

At least some embodiments of the present disclosure provide a display panel comprising the color filter substrate as described above.

At least some embodiments of the present disclosure provide a display device comprising the display panel as described above.

In some embodiments of the present disclosure, the display device comprises a plurality of the display panels spliced with each other.

The additional aspects and advantages of the present disclosure will be partly given in the following description, which will become obvious from the following description, or be understood through the practice of the present disclosure.

### BRIEF DESCRIPTION OF THE DRAWINGS

The above and/or additional aspects and advantages of the present disclosure will become obvious and easy to be understood from the following description of the embodiments in conjunction with the accompanying figures, in which:

FIG. 1 is a partial schematic diagram showing a color filter substrate of related arts;

FIG. 2 is a cross-sectional view taken along line N-N in FIG. 1;

FIG. 3 is a schematic top view illustrating a structure of a color filter substrate according to an embodiment of the present disclosure;

FIG. 4 is a schematic top view illustrating a structure of a color filter substrate according to another embodiment of the present disclosure;

FIG. 5 is a schematic top view illustrating a structure of a color filter substrate according to still another embodiment of the present disclosure;

FIG. 6 is a schematic cross-sectional view illustrating a cross section of the color filter substrate illustrated in FIG. 5 taken along line M-M;

FIG. 7 is a schematic cross-sectional structural view illustrating a display panel according to an embodiment of the present disclosure;

FIG. 8 is a schematic structural view illustrating a display device according to an embodiment of the present disclosure; and

FIG. 9 is a schematic structural view illustrating a display device according to another embodiment of the present disclosure.

### REFERENCE SIGNS

1—color film substrate;
101—substrate;
102—color filter layer;
103—black matrix;
1031—first black matrix structure;
1032—second black matrix structure;
2—Sealant;
3—array substrate;
4—drive circuit;
10—display area;
10a—first side;
10b—second side;
20—non-display area;
R—red filter unit;
G—green filter unit;
B—blue filter unit;
I—first display panel;
II—second display panel.

### DETAILED DESCRIPTION OF THE EMBODIMENTS

The present disclosure will be described in detail below. Examples of embodiments of the present disclosure are illustrated in the accompanying drawings, wherein same or similar reference signs indicate same or similar components or components with the same or similar functions. In addition, in a case that detailed description of the known technology is unnecessary for the features of the present disclosure, it will be omitted. Embodiments described below with reference to the figures are exemplary, and are only intended to explain the present disclosure, and cannot be construed as a limit to the present disclosure.

One of ordinary skill in the art can understand that, unless otherwise defined, all terms (including technical and scientific terms) used herein have the same meanings as those commonly understood by one of ordinary skill in the art to which this disclosure pertains. It should also be understood that terms such as those defined in general dictionaries should be understood to have a meaning consistent with the meaning in the context of the prior art, and unless specifically defined as here, they should not be explained in an ideal meaning or an overly formal meaning.

One of ordinary skill in the art can understand that, unless specifically stated otherwise, the singular forms “a”, “an”, “said” and “the” used herein may also include plural forms. It should be further understood that the term “comprising” used in the present disclosure refers to the presence of the described features, integers, steps, operations, elements and/or components, but does not exclude the presence or addition of one or more other features, integers, steps, operations, elements, components and/or groups of them.

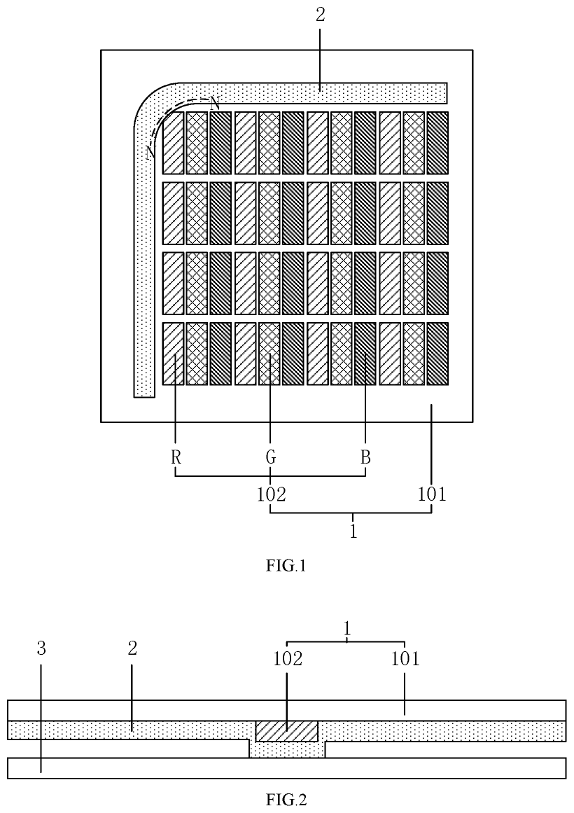

As shown in FIGS. 1 and 2, in view of that a sealant layer 2 is required to bond an array substrate 3 and a color film substrate 1 of a LCD, the sealant layer 2 has a shape of arc at a corner region due to the limitation of the coating processing, and conventional LCDs typically have a rectangular display area, the inventors of the present disclosure found that the color filter layer 102 of the color filter substrate of the LCD overlaps the sealant layer 2 at the corner region of the display area, and at a non-corner region, the color filter layer 102 does not overlap the sealant layer 2. This will cause that the film layers between the array substrate 3 and the color filter substrate 1 has a thickness at the corner region is greater than the thickness at the non-corner region, resulting in uneven peripheral supporting between the array substrate 3 and the color filter substrate 1, making the corner region of the display screen yellowing.

What the inventor knows is that a shielding method is used to avoid yellowing at the four corner regions of the display screen, but this is not conducive to narrow the display screen frame.

At least one embodiments of the present disclosure provide a color filter substrate, a display panel and a display device.

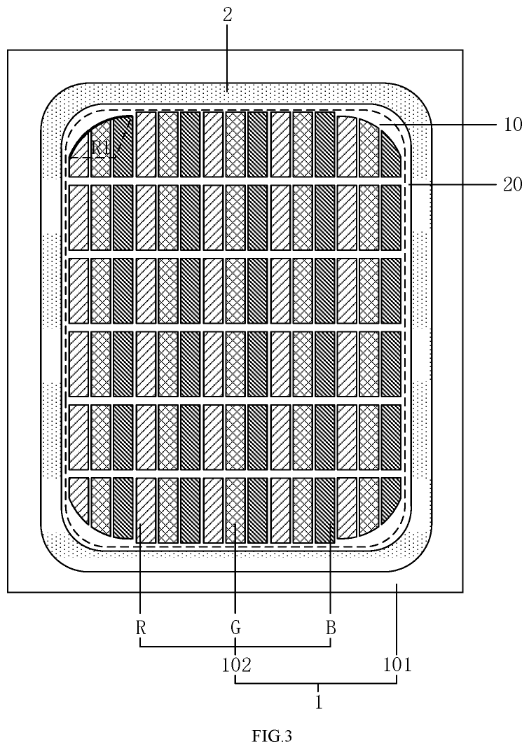

At least one embodiment of the present disclosure provides a color filter substrate 1. As illustrated in FIG. 3, the color filter substrate 1 includes a display area and a frame area surrounding the display area. The color filter substrate 1 includes a substrate 101 and a color filter layer 102 disposed on the substrate 101. The color filter layer 102 is disposed in the display area, and the color filter layer 102 has a non-right-angled shape at a corner region of the display area.

In the color filter substrate according to embodiments of the present disclosure, the color filter layer 102 is designed to have a non-right-angled shape at the corner region. Thus, in a cell-assembling processing for bonding the color filter substrate and an array substrate, a distance between a part of the color filer layer 102 at the corner region of the display area and the sealant layer 2 coated on the array substrate is greater than or equal to a distance between a part of the color filter layer 102 at the non-corner region of the display area and the sealant layer 2 coated on the array substrate. Thus, it may be avoided that the sealant layer overlaps the color filter at the corner region, and it is guaranteed that a thickness of the sealant layer is uniform after the color filter substrate and the color filter substrate 3 are bonded so as to form a uniform support, thereby avoiding yellowing at the corner region of the display panel while achieving a narrow frame.

Please continue referring to FIG. 3, the color filter substrate 2 includes a plurality of pixels arranged in array, and each of the pixels includes a plurality of sub-pixels. The color filter layer 102 includes filter units of different colors corresponding to each sub-pixel. For example, the color filter layer 102 may include a red filter unit R, a green filter unit G, and a blue filter unit B. In an embodiment of the present disclosure, a shape of at least one filter unit for one pixel at each corner region of the display area 10 is designed, so that the at least one filter unit at the corner region of the display area has a non-right-angled shape. In this way, in a subsequent process of cell-assembling the color filter with the array substrate, a distance between the at least one filter unit disposed at the corner region of the display area and the sealant layer 2 coated on the color filter substrate or the array substrate is greater than or equal to a distance between a filter unit at the non-corner region of the display area 10 and the sealant layer 2.

In the color filter substrate according to the present disclosure, since only the shape of the at least one filter unit corresponding to one pixel is designed, the display area is still rectangular visually.

In actual design, the color filter layer 102 at the corner region of the display area may be designed to have different shapes to increase the distance between the color filter layer 102 and the sealant layer 2, so as to ensure that a distance between a part of the color filter layer 102 at the corner region of the display area 10 and the sealant layer 2 is greater than or equal to a distance between a part of the color filter layer at the non-corner region of the display area 10 and the sealant layer 102. The detailed description is given below.

In some embodiments of the present disclosure, as illustrated in FIG. 3, the color filter layer 102 has a rounded shape at the corner region of the display area 10.

In some embodiments of the present disclosure, the rounding radius R1 of the color filter layer 102 at the corner region of the display area 10 ranges from 0.5 mm to 5 mm.

In the color filter substrate according to the embodiment of the present disclosure, it may be effectively avoided that the color filter layer 102 overlaps the sealant layer 2 while achieving a narrow frame, and the display area also looks like a rectangle as conventionally, thereby not affecting the display effect.

In some embodiments of the present disclosure, the color filter substrate 2 includes a plurality of pixels arranged in array, and each of the pixels includes sub-pixels of different colors. For example, the color filter layer 102 includes a red filter unit R, a green filter unit G, and a blue filter unit B corresponding to each sub-pixel. Depending on a resolution of the display panel, the color filter layer 102 has a shape of arc with a radius R1 ranging from 0.5 mm to 5 mm at the corner region. Taking the color filter substrate illustrated in FIG. 3 as an example, only a portion of the color filter layer 102 corresponding to a pixel located at the corner region of the display area is designed so that the corner region of the display area 10 is rounded. In this embodiment, it is achieved by designing the shapes of the filter units corresponding to all the sub-pixels of the pixel. Of course, instead, it may be achieved by designing shapes of the filter units corresponding to some of the sub-pixels of the pixel.

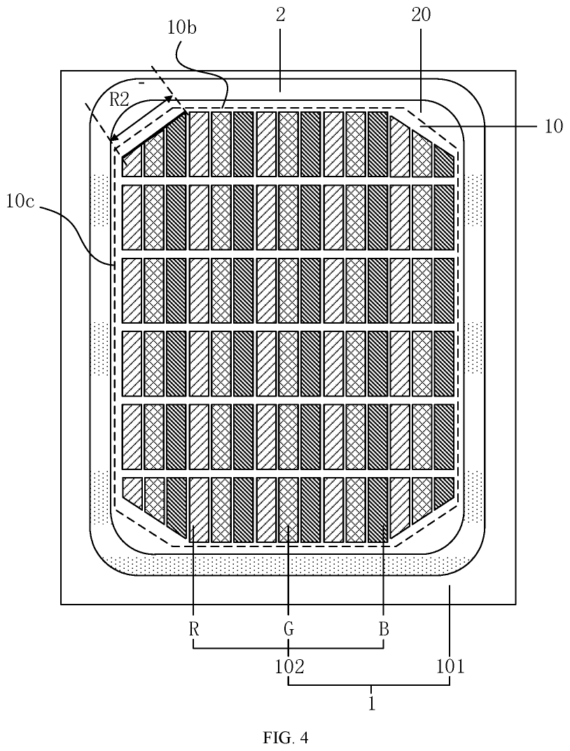

In some embodiments of the present disclosure, as illustrated in FIG. 4, a display area 10 includes a first side 10b and a second side 10c that adjacent to each other, and the color filter layer 102 has a chamfer at a corner region where the first sides 10b and second sides 10c intersects with each other. For example, a chamfered angle of the chamber is 45°, and a length of the chamber ranges from 0.5 mm to 8 mm.

In some embodiments of the present disclosure, the color filter substrate 2 includes a plurality of pixels arranged in an array, and each of the pixels includes a plurality of sub-pixels of different colors. For example, the color filter layer 102 includes a red filter unit R, a green filter unit G, and a blue filter unit B corresponding to each sub-pixel, respectively. Depending on a resolution of the display panel, a length of the chamfer of the color filter layer 102 at the corner region of the display panel 10 ranges from 0.5 mm to 8 mm. Taking the color filter substrate illustrated in FIG. 4 as an example, only a portion of the color filter layer 102 corresponding to one pixel is designed so that the color filter layer 102 has a chamfer at the corner region of the display area 10. In the embodiment as illustrated in FIG. 4, all the filter units corresponding to all the sub-pixels of the pixel is designed so as to make the color filter layer have a chamfer. Of course, a part of the filter units corresponding to the sub-pixels of the pixel are designed to make the color filter layer have a chamfer.

The color filter substrate according to the present disclosure can effectively avoid overlapping of the color filter layer 102 and the sealant layer 2 while achieving a narrow frame. And further, the display area looks like a rectangle as conventionally, without affecting the display effect.

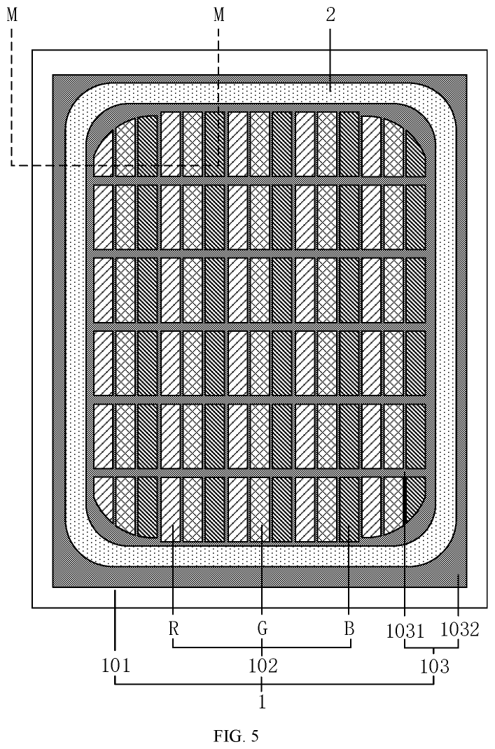

In some embodiments of the present disclosure, as illustrated in FIGS. 5 and 6, the color filter substrate 1 further includes a black matrix 103 disposed on a same side of the substrate 101 as the color filter layer 102, and the black matrix 103 includes a first black matrix structure 1031 disposed in the display area 10 and a second black matrix structure 1032 disposed in the frame area 20, the color filter layer 102 overlap the second black matrix structure 1032 at least partially.

The color filter layer 102 may be designed to partially overlap or not to overlap the first black matrix structure 1031 according to actual requirements, which is not limited in the present disclosure.

In some embodiments of the present disclosure, an orthographic projection of the sealant layer 2 on the substrate 101 is within an orthographic projection of the second black matrix structure 1032 on the substrate 101.

In the color filter substrate 1 according to the embodiments of the present disclosure, the first black matrix structure 1031 disposed in the display area 10 is designed in the same manner as a black matrix of a conventional color filter substrate, which will not be elaborated herein.

In the color filter substrate 1 according to the embodiments of the present disclosure, the color filter layer 102 overlaps the second black matrix 1032 at least partially so as to prevent light leakage, thereby improving display effect.

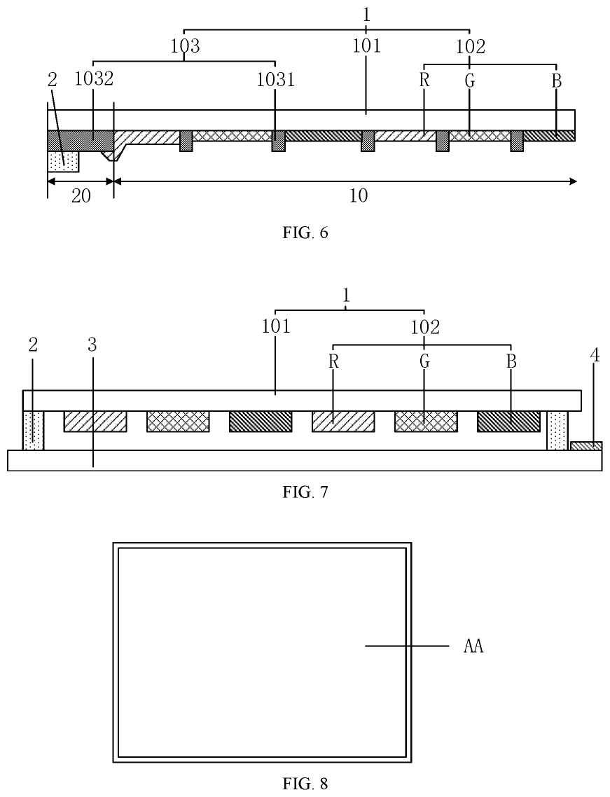

Based on the same inventive concept, at least some of the present disclosure provide a display panel, as illustrate in FIG. 7, the display panel includes an array substrate 3, the color filter substrate 1 according to the above embodiments, and a sealant layer 2 disposed between the array substrate and the color filter substrate. The display panel according to the present disclosure has the beneficial effects of the color filter substrate in the above-mentioned embodiments, which will not be repeated here.

In some embodiments of the present disclosure, the display panel further includes a driving circuit 4 bonded on the array substrate, the driving circuit 4 supplying driving signals to the display panel. It should be noted that the driving circuit 4 may be a driving chip, or a flexible circuit board and the like.

Based on the same inventive concept, at least one embodiment of the present disclosure further provide a display device, as illustrated in FIG. 8, the display device includes the display panel according to the foregoing embodiment. The display device according to embodiments of the present disclosure has the beneficial effects of the display panel according to the above-mentioned embodiments, which will not be elaborated here.

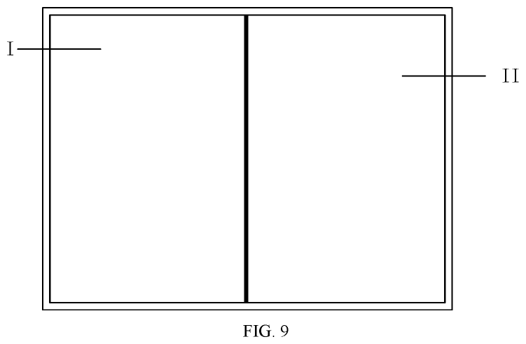

In some embodiments of the present disclosure, the display device according to the embodiments of the present disclosure includes a plurality of display panels spliced with each other. For example, as illustrated in FIG. 9, the display device may include a first display panel I and a second display panel II. That is, the display device according to the embodiments of the present disclosure is a spliced display device. As the color filter layer of the color filter substrate at the corner region is designed to have a non-right-angled structure, yellowing at the corner region of the display device is avoided while achieving a narrow frame. Thus, the display panel is applicable to a spliced display device.

Through the embodiments of the present disclosure, at least the following beneficial effects may be produced:

In the color filter substrate, the display panel, and the display device according to the embodiments of the present disclosure, a part of the color filter layer at the corner region is designed so as to make a distance between a part of the color filter layer at the corner region and the sealant layer is greater than or equal to a distance between a part of the color filter layer at the non-corner region and the sealant layer, thus it is avoided that the sealant layer at the corner region overlaps the color filter layer, and it is guaranteed that a thickness of the sealant layer after cell-assembling the color filter substrate and the array substrate is uniform, and supporting is regular, thereby avoiding yellowing at the corner regions of the display panel while achieving a narrow frame.

In the description of the present disclosure, it should be understood that the terms that indicates orientation or positional relationship, such as “center”, “upper”, “lower”, “front”, “rear”, “left”, “right”, “vertical”, “horizontal”, “top”, “bottom”, “inner”, “outer”, and the like, are based on the orientation or positional relationship illustrated in the drawings, and are only for the convenience of describing the present disclosure and simplifying the description, rather than indicating or implying that the referred device or element must have a specific orientation, or be configured and operated in a specific orientation, and therefore the terms cannot be construed as a limit to the present disclosure.

The terms “first” and “second” are only used for descriptive purposes, and cannot be understood as indicating or implying relative importance or implicitly indicating the number of indicated technical features. Thus, the features defined by the term such as “first” and “second” may explicitly or implicitly include one or more of these features. In the description of the present disclosure, unless otherwise specified, the term “a plurality of” means two or more.

In the description of the present disclosure, it should be noted that, unless otherwise clearly specified and defined, the terms “installed”, “connected”, and “connection” should be understood in a broad sense, for example, it may be a fixed connection, a detachable connection, or an integrated connected, or be connected directly or through an intermediate medium, or it may be an internal communication between two components. For one of ordinary skill in the art, the meaning of the above-mentioned terms in the present disclosure may be understood according to the context.

In the description of the present disclosure, features, structures, materials or characteristics may be combined in any one or more embodiments in a suitable manner.

It should be understood that, although various steps in the flowchart of the figures are displayed in sequence as indicated by the arrows, these steps are not necessarily performed in sequence in the order indicated by the arrows. Unless explicitly stated in the present disclosure, execution of these steps is not strictly limited in order, and they can be executed in other orders. Moreover, at least part of the steps in the flowchart of the figures may include multiple sub-steps or multiple stages. These sub-steps or stages are not necessarily executed at the same time, but may be executed at different times, and execution of the steps are also It is not necessarily performed sequentially, but may be performed alternately or in turns with other steps or at least a part of sub-steps or stages of other steps.

The above are only some of the embodiments of the present disclosure. It should be noted that one of ordinary skill in the art may make improvements and modifications to the present disclosure without departing from the operation principles of the present disclosure, and these improvements and modifications also falls into the protection scope of the present disclosure.

1. A color filter substrate, comprising a display area and a frame area surrounding the display area, wherein the color filter substrate further comprises:
a substrate; and
a color filter layer disposed on the substrate and in the display area, wherein the color filter layer has a non-right-angled shape at a corner region of the display area.

2. The color filter substrate according to claim 1, wherein the color filter substrate comprises a plurality of pixels arranged in array, and each of the plurality of pixels comprise a plurality of sub-pixels;
the color filter layer comprises a plurality of filter units of different colors corresponding to each of the plurality of sub-pixels; and
at least one filter unit corresponding to one of the plurality of pixels at the corner region of the display area has a non-right-angled shape.

3. The color filter substrate of claim 1, wherein the color filter layer has a rounded shape at the corner region of the display area.

4. The color filter substrate according to claim 3, wherein a rounding radius of the color filter layer at the corner region of the display area ranges from 0.5 mm to 5 mm.

5. The color filter substrate of claim 1, wherein the color filter layer has a chamfer at the corner region of the display area.

6. The color filter substrate according to claim 5, wherein a chamfered angle of the chamfer is 45° and a length of the chamfer ranges from 0.5 mm to 8 mm.

7. The color filter substrate according to claim 1, further comprising:
a black matrix disposed a same side of the substrate as the color filter layer, wherein the black matrix comprises a first black matrix structure disposed in the display area and a second black matrix structure disposed in the frame area, and the color filter layer overlaps the second black matrix structure at least partially.

8. The color filter substrate according to claim 1, further comprising a sealant layer disposed in the frame area and having a shape of arc in the corner region, a distance between a part of the color filter layer with the non-right angled structure and the sealant layer is greater than or equal to a distance between other part of the color filter layer rather than the part of the color filter layer with the non-right angled structure and the sealant layer.

9. The color filter substrate according to claim 8, wherein the color filter substrate comprises a plurality of pixels arranged in array, and each of the plurality of pixels comprise a plurality of sub-pixels;
the color filter layer comprises filter units of different colors corresponding to each of the plurality of sub-pixels;
wherein at least one filter unit corresponding to one pixel of the plurality of pixels at a corner region of the display area has the non-right-angled shape, and a distance between the at least one filter unit and the sealant layer is greater than or equal to a distance between filter units rather than the at least one filter unit and the sealant layer.

10. The color filter substrate according to claim 9, wherein the at least one filter unit has a shape of arc at the corner region of the display area.

11. The color filter substrate according to claim 10, wherein an arc radius of the at least one filter unit at the corner region of the display area ranges from 0.5 mm to 5 mm.

12. The color filter substrate according to claim 8, wherein the at least one filter unit has a chamfer at the corner region of the display area.

13. The color filter substrate according to claim 12, wherein a chamfered angle of the chamfer is 45°, and a length of the chamfer ranges from 0.5 mm to 8 mm.

14. The color filter substrate according to claim 8, further comprising a black matrix disposed on a same side of the substrate as the color filter layer, wherein the black matrix comprising a first black matrix structure disposed in the display area and a second black matrix structure disposed in the frame area, and the color filter layer overlaps the second black matrix structure at least partially.

15. A display panel comprising the color filter substrate according to claim 1.

16. A display panel, comprising the color filter substrate according to claim 8.

17. A display device comprising the display panel according to claim 15.

18. A display device comprising the display panel according to claim 16.

19. The display device according to claim 17, comprising a plurality of the display panels spliced with each other.

20. The display device according to claim 18, comprising a plurality of the display panels spliced with each other.
